(19) United States
(12) Patent Application Publication
(10) Pub. No.: US 2026/0113245 A1
(43) Pub. Date: Apr. 23, 2026

(54) Monitoring a target system

(71) Applicant: Elisa Oyj, Helsinki (FI)

(72) Inventor: Viivi UURTIO, Helsinki (FI)

(21) Appl. No.: 19/475,074

(22) PCT Filed: Mar. 27, 2024
(86) PCT No.: PCT/FI2024/050149

§ 371 Date: Oct. 14, 2025

(30) Foreign Application Priority Data
Jul. 3, 2023 (FI) 20235781

(51) Int. Cl. H04L 41/142; H04L 41/16; H04L 43/04

(52) U.S. Cl. CPC H04L 41/142; H04L 41/16; H04L 43/04

(57) ABSTRACT

A computer implemented method for analyzing a target system for the purpose of controlling the target system. The method includes receiving (310) a matrix of observations, wherein rows of the matrix represent observations related to the target system and columns of the matrix represent values of different variables for each observation, or vice versa: performing (311) anomaly detection on the matrix of observations to obtain a matrix of anomaly coefficients: clustering (312) the matrix of anomaly coefficients to obtain clustered anomaly coefficients; determining (313) observations that substantially deviate from the core of any cluster in the clustered anomaly coefficients to be anomalous observations; and providing (314) results of the anomaly detection for detecting problems and taking corrective actions.

### TECHNICAL FIELD

The present disclosure generally relates to monitoring a target system. The disclosure relates particularly, though not exclusively, to monitoring observations from the target system for the purpose of controlling the target system.

### BACKGROUND

This section illustrates useful background information without admission of any technique described herein representative of the state of the art.

There are various automated measures that monitor and analyze operation of complex target systems, such as mobile communication networks or industrial processes, in order to detect problems so that corrective actions can be taken.

For example, anomaly detection models may be used for monitoring and analyzing observations from a target system (e.g. measurement results) to identify anomalies or data points that stand out from the rest of the data. Anomaly detection refers to identification of data points, items, events, or other variables that do not conform to an expected pattern of a given data sample or data vector. Anomaly detection models can be trained to learn the structure of normal data samples. The models output an anomaly score for an analysed sample, and the sample may be classified as an anomaly, if the anomaly score exceeds some predefined threshold. Such models include for example k nearest neighbors (kNN), local outlier factor (LOF), principal component analysis (PCA), kernel principal component analysis, independent component analysis (ICA), isolation forest, autoencoder, angle-based outlier detection (ABOD), and others. Different models represent different hypotheses about how anomalous points stand out from the rest of the data.

Now a new approach is provided for monitoring a target system.

### SUMMARY

The appended claims define the scope of protection. Any examples and technical descriptions of apparatuses, products and/or methods in the description and/or drawings not covered by the claims are presented not as embodiments but as background art or examples useful for understanding the present disclosure.

According to a first example aspect there is provided a computer implemented method for monitoring a target system for the purpose of controlling the target system. In an example, the method comprises
receiving a matrix of observations, wherein rows of the matrix represent observations related to the target system and columns of the matrix represent values of different variables for each observation, or vice versa;
performing anomaly detection on the matrix of observations to obtain a matrix of anomaly coefficients;
clustering the matrix of anomaly coefficients by a clustering algorithm to obtain clustered anomaly coefficients;
determining observations that substantially deviate from the core of any cluster in the clustered anomaly coefficients to be anomalous observations; and
providing information related to determined anomalous observations for detecting problems and taking corrective actions in the target system.

According to a second example aspect of the present invention, there is provided an apparatus comprising means for performing the method of the first aspect or any related embodiment. The means may comprise a processor and a memory including computer program code, and wherein the memory and the computer program code are configured to, with the processor, cause the performance of the apparatus.

According to a third example aspect of the present invention, there is provided a computer program comprising computer executable program code which, when executed by a processor, causes an apparatus to perform the method of the first aspect or any related embodiment.

According to a fourth example aspect there is provided a computer program product comprising a non-transitory computer readable medium having the computer program of the third example aspect stored thereon.

In some example embodiments of the first, second, third, or fourth example aspect, the observations that substantially deviate from the core of any cluster in the clustered anomaly coefficients are observations that are not directly reachable from the core of any cluster in the clustered anomaly coefficients.

In some example embodiments of the first, second, third, or fourth example aspect, the clustering algorithm is a non-parametric clustering algorithm.

In some example embodiments of the first, second, third, or fourth example aspect, the clustering algorithm is a density-based clustering algorithm that maximizes kernel-target alignment score.

In some example embodiments of the first, second, third, or fourth example aspect, the clustering algorithm is DBSCAN or OPTICS.

In some example embodiments of the first, second, third, or fourth example aspect, hyperparameters of the clustering algorithm are tuned to maximize kernel-target alignment score.

In some example embodiments of the first, second, third, or fourth example aspect, the hyperparameters that are tuned comprise at least a neighborhood parameter and a minimum number of observations of a core of a cluster.

In some example embodiments of the first, second, third, or fourth example aspect, the target system is a mobile communication network, an industrial process, a life science application, or an asset performance optimization system.

Any foregoing memory medium may comprise a digital data storage such as a data disc or diskette; optical storage; magnetic storage; holographic storage; opto-magnetic storage; phase-change memory; resistive random-access memory; magnetic random-access memory; solid-electrolyte memory; ferroelectric random-access memory; organic memory; or polymer memory. The memory medium may be formed into a device without other substantial functions than storing memory or it may be formed as part of a device with other functions, including but not limited to a memory of a computer; a chip set; and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows a system according to an example embodiment;

FIG. 2 shows a block diagram of an apparatus according to an example embodiment;

FIG. 3 shows a flow chart of a method according to an example embodiment; and

FIG. 4 shows analysis results of an example case.

### DETAILED DESCRIPTION

In the following description, like reference signs denote like elements or steps.

A challenge in monitoring observations and detecting anomalies thereof in relation to complex target systems, such as mobile communication networks, life science applications and industrial processes, is that the amount of data is often huge and therefore automated methods are needed. A further challenge is that it is not straightforward to identify, which anomalies are so severe that they need further analysis and/or corrective actions in the target system, and which anomalies are perhaps less important or less severe.

Observations to be analyzed with an anomaly detection algorithm may be arranged in an observation matrix, wherein rows of the matrix represent observations related to the target system and columns of the matrix represent values of different variables (e.g. measurement results) for each observation, or vice versa columns representing observations and rows representing values of different variables. The output of the anomaly detection algorithm may be a matrix of same size as the observation matrix, but the entries of the output matrix contain coefficients describing variations related to the learnt behaviour during the training phase of the algorithm of the anomaly detection technique. In general, a row-sum of the entries of the output matrix (matrix of anomaly coefficients) can be used as an indicator of the level of anomalousness of the particular row (observation), but in that case there is a need to determine a threshold to distinguish the true anomalies from less important or less severe anomalies. That is, rows for which the row-sum of the matrix of anomaly coefficients exceeds the threshold are considered true anomalies. Determining such a threshold is, however, not straightforward.

Various embodiments of the present disclosure provide solutions that do not require the use of the threshold. This is achieved by various embodiments, where the matrix of anomaly coefficients is clustered, and observations that substantially deviate from the core of any cluster are considered to be anomalous observations. In this way, there is no need to determine a specific threshold for the anomaly coefficients. At least in some embodiments, the clustering is performed using a density-based clustering algorithm that maximises the kernel-target alignment score.

In an embodiment, a non-parametric clustering algorithm is used. In a non-parametric clustering algorithm, the number of clusters does not need to be pre-specified. For example Density-Based Spatial Clustering of Applications with Noise (DBSCAN) or Ordering Points To Identify the Clustering Structure (OPTICS) are such clustering algorithm.

In an embodiment, hyperparameters of the clustering model are tuned such that they maximise the kernel-target alignment score.

In the context of present disclosure, the observations that are analysed may comprise measurement results or other data obtained from the target system. The observations may involve, for example, data that represents network performance of a mobile communication network. In such case, the observations may include for example network probe data or performance data such as key performance indicator values, signal level, throughput, number of users, number of dropped connections, number of dropped calls etc.

Life science applications in which present embodiments may be applied include for example healthcare or biological applications. In such case, the observations may be described by variables that represent measurements from an organism, and the analysis of presently disclosed embodiments may facilitate the detection of anomalous observations.

In yet other alternatives, the observations may involve sensor data such as pressure, temperature, manufacturing time, electric measurements, yield of a production phase etc. of an industrial process, such as a semiconductor manufacturing process. Still further, the observations may involve data related to asset performance optimization.

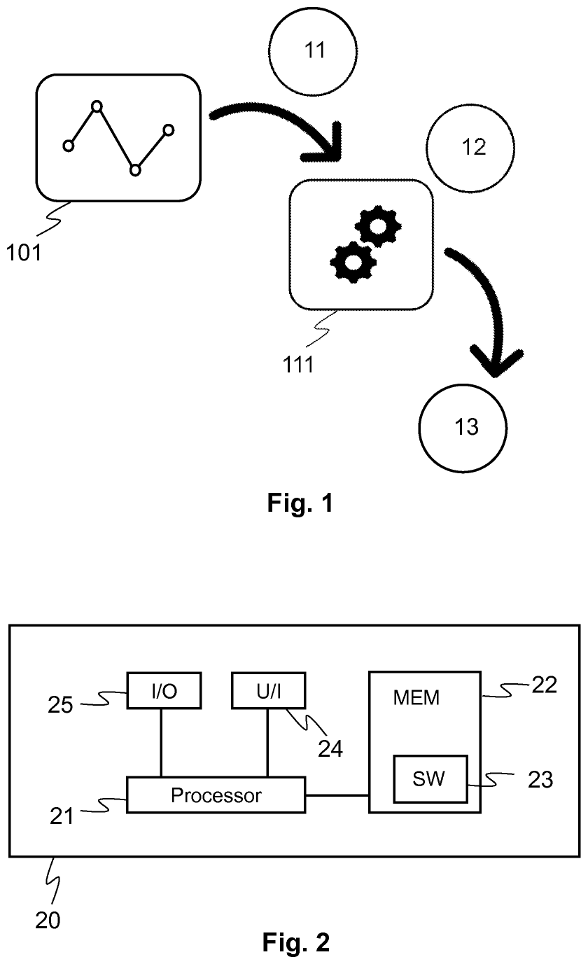

FIG. 1 schematically shows a system according to an example embodiment. The system comprises a controllable target system 101 and an automation system 111 configured to monitor and analyze observations from the target system 101. The automation system 111 implements analysis of observations from the target system according to one or more example embodiments. The target system 101 may be a communications network comprising a plurality of physical network sites comprising base stations and other network devices, or the target system 101 may be an industrial process, such as a semiconductor manufacturing process. Additionally or alternatively, the target system 101 may be a system running life science applications or asset performance optimizations tools.

In an embodiment the system of FIG. 1 operates as follows: In phase 11, the automation system 111 receives observations from the target system 101. In phase 12, the automation system 111 analyzes the measurement results, and in phase 13, the automation system 111 outputs the results of the analysis. The results of the analysis may include information about detected anomalies and/or observations associated with detected anomalies. This output may then be used for manually or automatically controlling the target system 101 for example to take corrective actions. The corrective actions may include for example adjusting parameters, changing components, making changes or otherwise fixing problems that may be considered to be the cause of the detected anomalies.

The process in the automation system 111 may be manually or automatically triggered. Further, the process in the automation system 111 may be periodically or continuously repeated.

FIG. 2 shows a block diagram of an apparatus 20 according to an embodiment. The apparatus 20 is for example a general-purpose computer or server or some other electronic data processing apparatus. The apparatus 20 can be used for implementing at least some embodiments of the invention. That is, with suitable configuration the apparatus 20 is suited for operating for example as the automation system 111 of foregoing disclosure.

The apparatus 20 comprises a communication interface 25; a processor 21; a user interface 24; and a memory 22. The apparatus 20 further comprises software 23 stored in the memory 22 and operable to be loaded into and executed in the processor 21. The software 23 may comprise one or more software modules and can be in the form of a computer program product.

The processor 21 may comprise a central processing unit (CPU), a microprocessor, a digital signal processor (DSP), a graphics processing unit, or the like. FIG. 2 shows one processor 21, but the apparatus 20 may comprise a plurality of processors.

The user interface 24 is configured for providing interaction with a user of the apparatus. Additionally or alternatively, the user interaction may be implemented through the communication interface 25. The user interface 24 may comprise a circuitry for receiving input from a user of the apparatus 20, e.g., via a keyboard, graphical user interface shown on the display of the apparatus 20, speech recognition circuitry, or an accessory device, such as a headset, and for providing output to the user via, e.g., a graphical user interface or a loudspeaker.

The memory 22 may comprise for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 20 may comprise a plurality of memories. The memory 22 may serve the sole purpose of storing data, or be constructed as a part of an apparatus 20 serving other purposes, such as processing data.

The communication interface 25 may comprise communication modules that implement data transmission to and from the apparatus 20. The communication modules may comprise a wireless or a wired interface module(s) or both. The wireless interface may comprise such as a WLAN, Bluetooth, infrared (IR), radio frequency identification (RF ID), GSM/GPRS, CDMA, WCDMA, LTE (Long Term Evolution) or 5G radio module. The wired interface may comprise such as Ethernet or universal serial bus (USB), for example. The communication interface 25 may support one or more different communication technologies. The apparatus 20 may additionally or alternatively comprise more than one of the communication interfaces 25.

A skilled person appreciates that in addition to the elements shown in FIG. 2, the apparatus 20 may comprise other elements, such as displays, as well as additional circuitry such as memory chips, application-specific integrated circuits (ASIC), other processing circuitry for specific purposes and the like. Further, it is noted that only one apparatus is shown in FIG. 2, but the embodiments of the present disclosure may equally be implemented in a cluster of shown apparatuses.

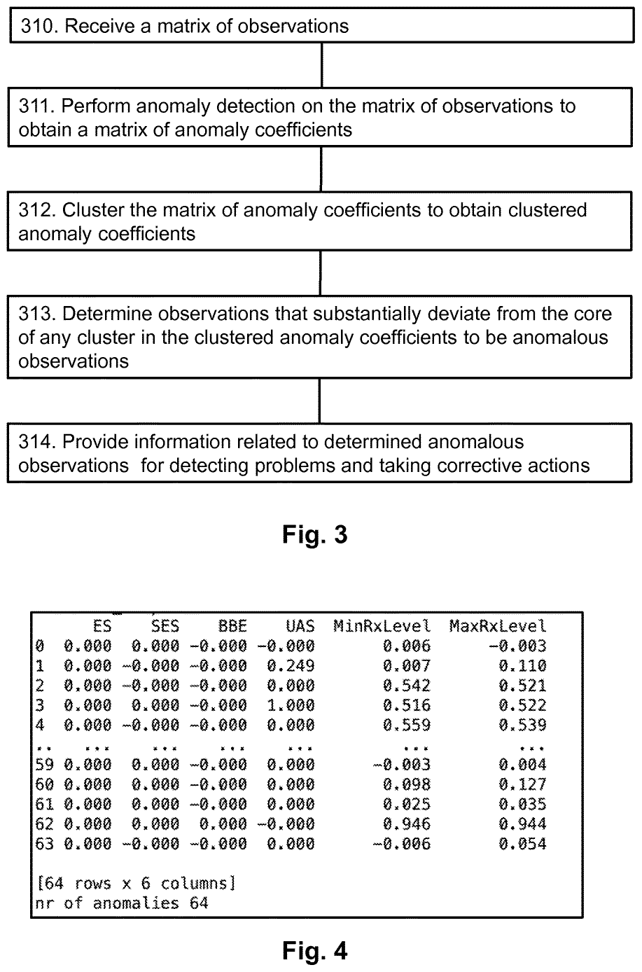

FIG. 3 shows a flow chart of a method according to an example embodiment. The method may be implemented in the automation system 111 of FIG. 1 and/or in the apparatus 20 of FIG. 2. The method is implemented in a computer and does not require human interaction unless otherwise expressly stated. It is to be noted that the method may however provide output that may be further processed by humans and/or the method may require user input to start.

The method of FIG. 3 comprises the following phases:
310: Receiving a matrix of observations related to a target system. In general, rows of the matrix represent observations related to the target system and columns of the matrix represent values of different variables for each observation, or vice versa.
311: Performing anomaly detection on the matrix of observations to obtain a matrix of anomaly coefficients. The matrix of anomaly coefficients may be the same size as the matrix of observations. Further, this phase may include some preprocessing that may highlight most significant anomaly coefficients in the matrix, although this is not mandatory.
312: Clustering the matrix of anomaly coefficients to obtain clustered anomaly coefficients. The clustering is performed using a clustering algorithm.

In an embodiment, the clustering algorithm is a non-parametric clustering algorithm. In an embodiment, the clustering algorithm is a density-based clustering algorithm that maximizes kernel-target alignment score. For example, DBSCAN or OPTICS may be used.
314: Determining observations that substantially deviate from the core of any cluster in the clustered anomaly coefficients to be anomalous observations. In an embodiment, observations that substantially deviate from the core of any cluster in the clustered anomaly coefficients are observations that are not directly reachable from the core of any cluster in the clustered anomaly coefficients. For the sake of clarity it may be defined that an observation that substantially deviates from the core of any cluster in the clustered anomaly coefficients is determined based on detecting that the anomaly coefficient (determined in step 311) that corresponds to the observation substantially deviates from the core of any cluster.
315: Providing information related to determined anomalous observations for detecting problems and taking corrective actions in the target system.

In general the clustering algorithm operates so that first it is determined which observations a close to each other to be considered neighbors. After this it is determined which of the observations have sufficient number of neighbors to be considered core observations. Observations that do not have sufficient number of neighbors are considered non-core-observations. Non-core-observations are included in clusters of core observations if they are close enough. In an embodiment of present disclosure, the non-core-observations that are not close enough to be included in any of the clusters are considered anomalous observations.

The method of FIG. 3 may further comprise (not shown in FIG. 3) tuning hyperparameters of the clustering algorithm to maximize kernel-target alignment score. The hyperparameters that are tuned may include for example a neighborhood parameter and a minimum number of observations of a core of a cluster. The neighborhood parameter may be referred to as eps and the minimum number of observations may be referred to as min_samples. It can be defined that eps is a parameter the defines a suitable neighbor distance for each observation (i.e. how close to each other the observations need to be to be considered neighbors). It can be defined that min_samples defines minimum required number of neighbors for an observation to be considered a core observation

In an embodiment, the hyperparameters eps and min_samples are selected through cross-validation such that the kernel-target alignment score,

$$\frac{trace ( {K}_{linear} {K}_{linear} ( y , y ) )}{{‖ {K}_{linear} ‖}_{F} {‖ {K}_{linear} ( y , y ) ‖}_{F}} ,$$

between a kernelised matrix of anomaly coefficients and a target matrix, Kₗᵢₙₑₐᵣ(y, y), obtained by the labels, y, from the clustering algorithm is maximised.

FIG. 4 shows analysis results of an example case. In the example, 17633 observations are obtained from network nodes and 6 variables are measured. The measured variables are: errored second(ES), severely errored second (SES), background block error (BBE), unavailable seconds (UAS), minimum received signal level (MinRxLevel), and maximum received signal level (MaxRxLevel).

Table 1 below shows kernel-target alignment scores obtained during cross-validation at different eps (rows) values (0.005, 0.009, 0.01, and 0.1) and min_samples (columns) values (5, 7, 9, and 11).

TABLE 1

| | 5 | 7 | 9 | 11 |
|---|---|---|---|---|
| 0.005 | 0.147 | 0.475 | 0.160 | 0.160 |
| 0.009 | 0.295 | 0.315 | 0.300 | 0.353 |
| 0.01 | 0.333 | 0.333 | 0.277 | 0.318 |
| 0.1 | 0.487 | 0.475 | 0.472 | 0.472 |

From Table 1 it can be seen that maximum kernel-target alignment score 0.487 is obtained by eps=0.1 and min_samples=5. These can be considered optimal hyperparameter values.

The observations are clustered using DBSCAN algorithm with the optimal hyperparameter values. Result from the DBSCAN algorithm is shown in FIG. 4. There it can be seen that, out of the 17633 observations, 64 are identified as anomalies in this example case.

Without in any way limiting the scope, interpretation, or application of the claims appearing below, a technical effect of one or more of the example embodiments disclosed herein is improved analysis of measurement results of a complex target system. Various embodiments suit well for analyzing large sets of multivariate measurement results. Such analysis is impossible or at least very difficult to implement manually. Various embodiments provide for example that process variables of a complex target system may be monitored to control whether all parameters remain stable over time.

Without in any way limiting the scope, interpretation, or application of the appended claims, a technical effect of one or more of the example embodiments disclosed herein is that anomaly detection without using thresholds is enabled.

If desired, the different functions discussed herein may be performed in a different order and/or concurrently with each other. Furthermore, if desired, one or more of the before-described functions may be optional or may be combined.

Various embodiments have been presented. It should be appreciated that in this document, words comprise, include and contain are each used as open-ended expressions with no intended exclusivity.

The foregoing description has provided by way of non-limiting examples of particular implementations and embodiments a full and informative description of the best mode presently contemplated by the inventors for carrying out the aspects of the present disclosure. It is however clear to a person skilled in the art that the solutions of present disclosure are not restricted to details of the embodiments presented in the foregoing, but that they can be implemented in other embodiments using equivalent means or in different combinations of embodiments without deviating from the characteristics of the present disclosure.

Furthermore, some of the features of the afore-disclosed example embodiments may be used to advantage without the corresponding use of other features. As such, the foregoing description shall be considered as merely illustrative of the principles of the present disclosure, and not in limitation thereof. Hence, the scope of the present disclosure is only restricted by the appended patent claims.

1. A computer implemented method for monitoring a target system for the purpose of controlling the target system, wherein the target system is a mobile communication network; the method comprising
receiving a matrix of observations, wherein rows of the matrix represent observations related to the target system and columns of the matrix represent values of different variables for each observation, or vice versa;
performing anomaly detection on the matrix of observations to obtain a matrix of anomaly coefficients;
tuning hyperparameters of a clustering algorithm to maximize kernel-target alignment score through cross-validation with different hyperparameter values;
clustering the matrix of anomaly coefficients by the clustering algorithm to obtain clustered anomaly coefficients;
determining observations that substantially deviate from the core of any cluster in the clustered anomaly coefficients to be anomalous observations;
providing information related to determined anomalous observations for detecting problems and taking corrective actions in the target system.

2. The method of claim 1, wherein the clustering algorithm is a non-parametric clustering algorithm.

3. The method of claim 1, wherein the clustering algorithm is DBSCAN or OPTICS.

4. The method of claim 1, wherein the hyperparameters comprise at least a neighborhood parameter and a minimum number of observations of a core of a cluster.

5. The method of claim 1, wherein the observations represent network performance of the mobile communication network.

6. The method of claim 5, wherein the observations comprise network probe data or performance data.

7. The method of claim 5, wherein the observations comprise key performance indicator values, signal level, throughput, number of users, number of dropped connections, or number of dropped calls.

8. An apparatus comprising means for performing the method of claim 1.

9. The apparatus of claim 8, wherein the means comprise a processor and a memory including computer program code, and wherein the memory and the computer program code are configured to, with the processor, cause the performance of the apparatus.

10. A computer program comprising computer executable program code which when executed in an apparatus causes the apparatus to perform the method of claim 1.

11. The method of claim 2, wherein the clustering algorithm is DBSCAN or OPTICS.

12. The method of claim 1, wherein the clustering algorithm is DBSCAN.

13. The method of claim 1, wherein the clustering algorithm OPTICS.

14. The method of claim 2, wherein the observations represent network performance of the mobile communication network.

15. The method of claim 3, wherein the observations represent network performance of the mobile communication network.

16. The method of claim 4, wherein the observations represent network performance of the mobile communication network.

17. The method of claim 6, wherein the observations comprise key performance indicator values, signal level, throughput, number of users, number of dropped connections, or number of dropped calls.

18. The method of claim 1, wherein performing anomaly detection on the matrix of observations to obtain a matrix of anomaly coefficients comprises using a non-parametric density based clustering algorithm to obtain clustered anomaly coefficients, wherein the matrix of anomaly coefficients is the same size as the matrix of observations.

19. The method of claim 1, wherein a linear target matrix is used for the kernel-target alignment.
